(19) United States
(12) Patent Application Publication
(10) Pub. No.: US 2007/0060046 A1
(43) Pub. Date: Mar. 15, 2007

(54) Apparatus for repeating signal using microstrip patch array antenna

(75) Inventors: Yong-Min Lee, Daejon (KR); Jong-Won Eun, Daejon (KR); Seong-Pal Lee, Daejon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunication Research Institu, Daejon (KR)

(21) Appl. No.: 10/576,006

(22) PCT Filed: Apr. 27, 2004
(86) PCT No.: PCT/KR04/00967

§ 371 Date: Apr. 17, 2006

(30) Foreign Application Priority Data
Oct. 18, 2003 (KR) 10-2003-0072769

(51) Int. Cl. H04B 3/36; H04B 7/14

(52) U.S. Cl. 455/7; 455/25

(57) ABSTRACT

An apparatus for repeating a signal from a satellite using a microstrip patch array antenna is disclosed. The apparatus includes: a receiving unit for receiving the signal and amplifying the receiving signal; a radiating unit for radiating the amplified signal to the shadow area; and a feeding unit for feeding the amplified signal to the radiating unit.

### TECHNICAL FIELD

The present invention relates to an apparatus for repeating a signal using a microstrip patch array antenna; and, more particularly, to an apparatus for receiving a signal from a satellite in a shadow area by using a microstrip patch array antenna.

### BACKGROUND ART

Generally, the user of a mobile station can enjoy desired information such as news, movie and music with a high quality sound through a mobile satellite communication or a broadcasting system when a mobile station directly receives a signal of various information from a satellite transponder in the space without passing through an obstacle of the radio wave.

Moreover, a supply of mobile satellite communication terminal capable of receiving a satellite Internet signal and a satellite broadcast signal in a vehicle, a train, a ship or the like has been rapidly increased. Recently, the mobile communication terminal employs a mobile satellite receiving antenna in the structure of waveguide with a very light material or a microstrip patch array method in order to make the mobile communication terminal compact and light.

FIG. 1 is a conceptual view for explaining the path of signal in a conventional satellite communication system.

As shown, a broadcasting station or Internet service provider 110 transmits a service signal to a satellite 130 through a satellite base station 120 by using a super high frequency. The satellite 130 transmits the service signal from the satellite base station 120 to a mobile station 140. For receiving the service signal from the satellite 130, the mobile station 140 must be in a location where a line of sight to the satellite 130 is secured.

During traveling, the user of the mobile station 140 may pass through a shadow area, where the line of sight to the satellite is blocked, such as a tunnel, an underpass and a toll gate. When the user of the mobile station 140 passes the shadow area, the mobile station 140 cannot receive the service signal from the satellite 130 as long as passing the shadow area.

Therefore, the above-described conventional method for receiving the service signal from the satellite 130 causes discontinuity problem.

Disclosure of Invention

### Advantageous Effects

It is, therefore, an object of the present invention to provide an apparatus for receiving a signal from a satellite and repeating the signal to a mobile station in a shadow area by using microstrip patch array antennas.

In accordance with an aspect of the present invention, there is provided an apparatus for repeating a signal to a mobile station in a shadow area by using a microstrip patch array antenna, the apparatus including: a receiving unit for receiving the signal and amplifying the received signal; a radiating unit for radiating the amplified signal to the shadow area; and a feeding unit for feeding the amplified signal to the radiating unit.

### DESCRIPTION OF DRAWINGS

The above and other objects and features of the present invention will become better understood with regard to the following description of the preferred embodiments given in conjunction with the accompanying drawings, in which:

FIG. 1 is a conceptual view for explaining the path of signal in a conventional satellite communication system;

FIG. 2 is a block diagram illustrating a satellite repeater in accordance with a preferred embodiment of the present invention;

FIG. 3 is a conceptual view showing the paths of signals in a satellite communication system in accordance with a preferred embodiment of the present invention when a mobile station passes through an overpass;

FIG. 4 is a conceptual view illustrating the paths of signals in accordance with anther preferred embodiment of the present invention when a mobile station passes through an underpass;

FIGS. 5 to 6 are detailed diagrams showing a receiving block in FIG. 2;

FIGS. 7 to 8 are detailed diagrams representing a transmitting antenna in FIG. 2; and

FIG. 9 is a detailed diagram showing dual directional microstrip patch array antenna employed as a transmitting antenna in FIG. 2.

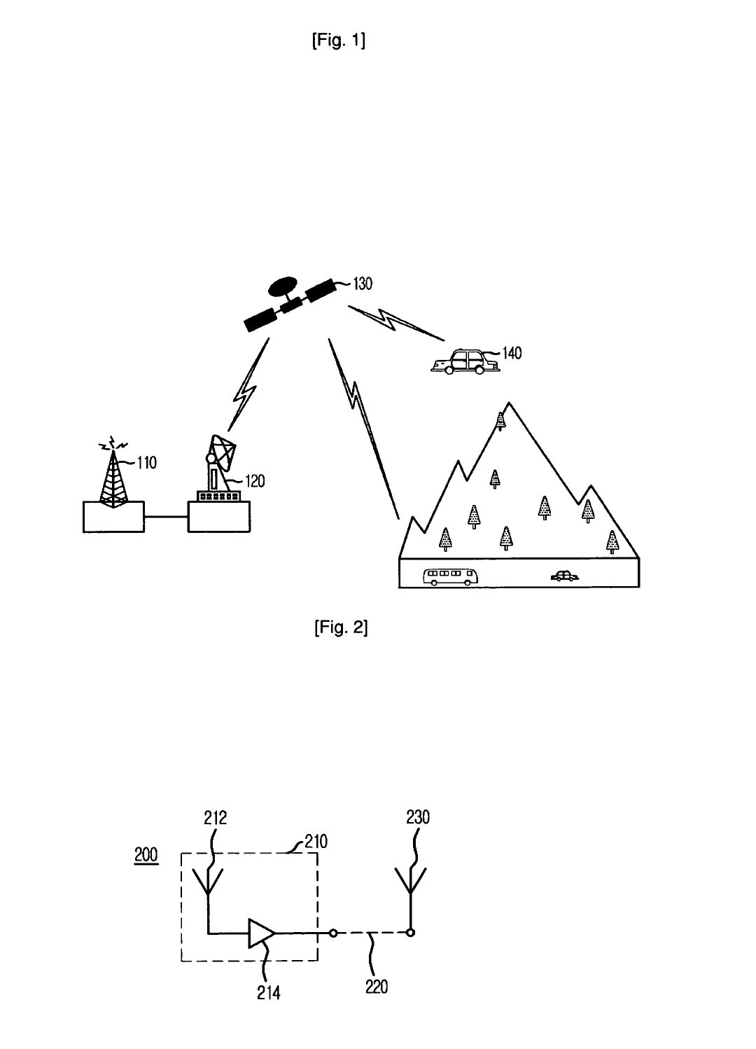

### MODE FOR INVENTION

Hereinafter, an apparatus for repeating a signal using a microstrip patch antenna according to the present invention will be described in more detail with reference to the accompanying drawings.

FIG. 2 is a block diagram illustrating a satellite repeater in accordance with a preferred embodiment of the present invention.

In accordance with a preferred embodiment of the present invention, the satellite repeater 200 includes a receiving block 210 provided with a receiving antenna 212 and an amplifier 214, a feeding line 220 and a transmitting antenna 230.

The receiving block 210 is installed outside of a shadow area where a line of sight to a satellite is secured and the transmitting antenna 230 is installed inside of the shadow area. The receiving block 210 and the transmitting antenna 230 are electrically connected through the feeding line 220.

The receiving block 210 directly receives a signal from the satellite through the receiving antenna 212 which is a microstrip patch array antenna. The received signal is amplified by the amplifier 214 for improving a signal-to-noise ratio and amplifying an amplitude of the receiving signal. The amplified signal is transmitted to the transmitting antenna 230 through the feeding line 220 and finally radiated to the mobile station in the shadow area by the transmitting antenna 230. The amplifier 214 may amplify the received signal for compensating a loss caused by transiting the signal to the transmitting antenna 230 through the feeding line 220. In a preferred embodiment of the present invention, the transmitting antenna 230 can be constructed by employing a microstrip patch array antenna.

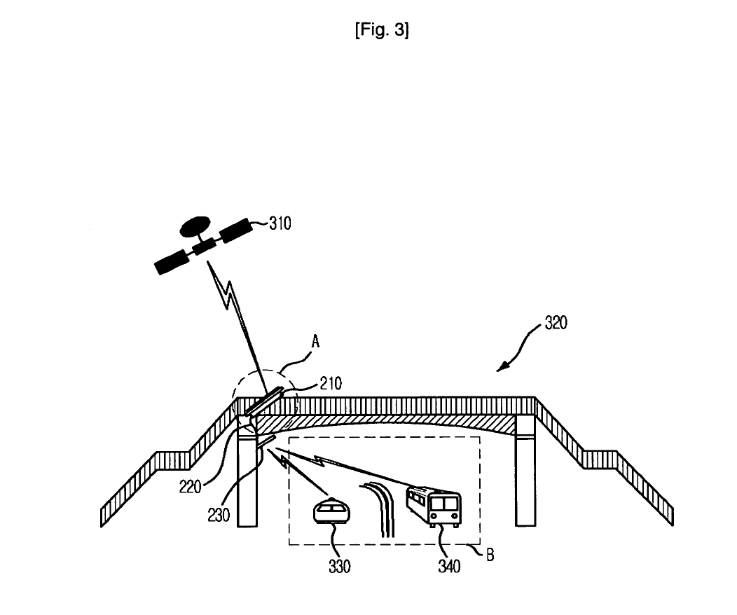

FIG. 3 is a conceptual view showing the paths of signals in a satellite communication system in accordance with a preferred embodiment of the present invention when a mobile station passes through an overpass.

In FIG. 3, an overpass 320, which is a comparatively narrow shadow area B in comparison to an under pass, inadvertently blocks the signal from a satellite 310. For radiating the signal from the satellite 310 to mobile stations in vehicles 330 and 340 within the shadow area B, the receiving block 210 is installed at a location A where is an outside of the shadow area B, whereby the line of sight to the satellite is secured. And, the transmitting antenna 230 is installed at a location inside of shadow area B. The receiving block 210 and the transmitting antenna 230 are electrically connected through the feeding line 220. Preferably, a distance between the receiving block 210 and the transmitting antenna 230 is maintained in a short range for preventing a loss caused by transiting the signal through the feeding line 220. A radiation angel of the transmitting antenna 230 can be adjusted in order to appropriately cover the shadow area B.

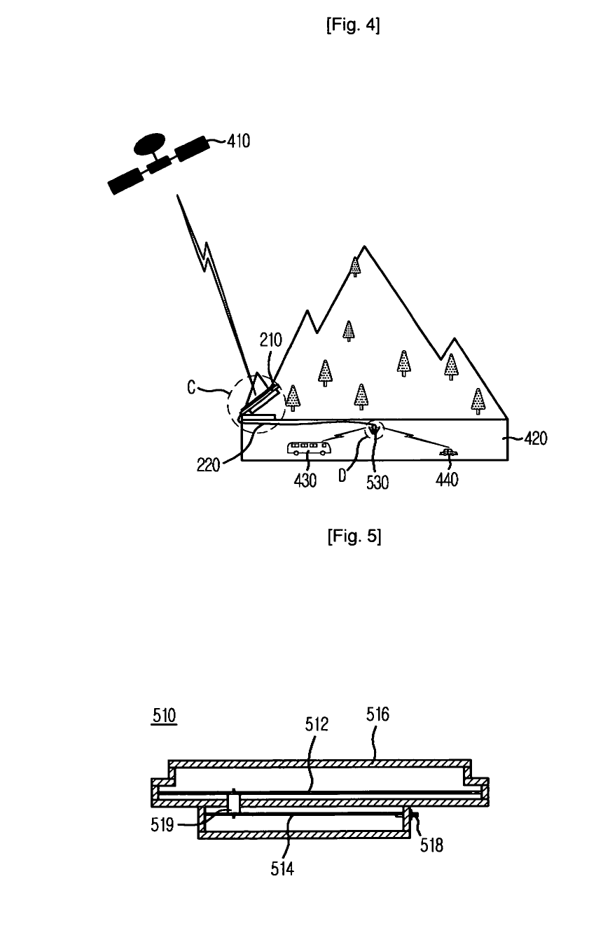

FIG. 4 is a conceptual view illustrating the paths of signals in accordance with anther preferred embodiment of the present invention when a mobile station passes through an underpass.

In FIG. 4, an underpass 420 blocks the signal to create a comparatively long shadow area. For radiating the signal from a satellite 410 to mobile stations in vehicles 430 and 440 in the shadow area, the receiving block 210 is installed at a location C where is an outside of the underpass 420, whereby the line of sight to the satellite 410 is secured. And the transmitting antenna 530 is installed at a location D inside of shadow area. The receiving block 210 and the transmitting antenna 530 are electrically connected through the feeding line 220.

A case shown in FIG. 4, a dual directional microstrip patch array antenna is implemented as the transmitting antenna 530 at middle of the underpass to cover all shadow area in the underpass. The transmitting antenna 530 of the dual directional microstrip patch array antenna includes a pair of microstrip patch array antennas and a divider. In case of using the dual directional microstrip patch array antenna, the received signal from the receiving block 210 is divided into a first signal and a second signal by the divider. Each of the first and the second signals is radiated by the pair of microstrip patch array antennas, along a direction opposite to each other, respectively.

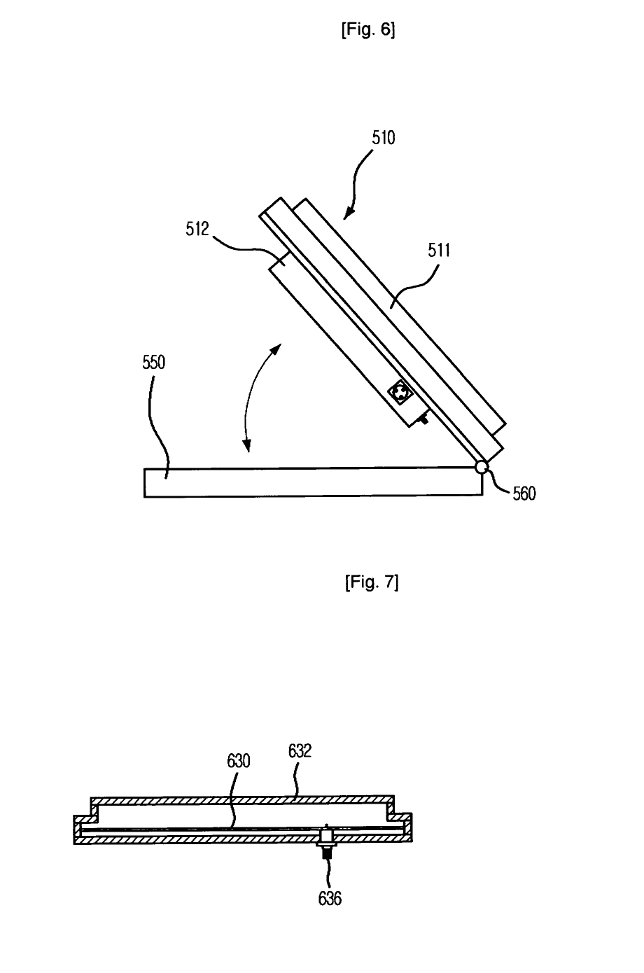

FIGS. 5 to 6 are detailed diagrams showing a receiving block in FIG. 2.

As shown in FIG. 5, the receiving block 510 includes a radome 516, a receiving antenna 512, an amplifier 514, a probe 519 and an output connector 518. The radome 516 is a cover for protecting inner electric circuits such as the receiving antenna 512 and the amplifier 514 from outdoor environments such as snow, rain and dust. The receiving antenna 512 of the microstrip patch array antenna is implemented as one piece with the amplifier 514 in FIG. 5. The probe 519 passes a signal from the receiving antennal 512 to the amplifier 514. An amplified signal from the amplifier 514 is passed to a feeding line through the output connector 518.

FIG. 6 shows a view for adjusting a receiving angle of the receiving block 510.

The receiving block 510 is rotatably connected to a supporting member 550 by a hinge 560. The supporting member 510 installed at an area where a line of sight to a satellite is secured. The receiving block 210 is rotated around the hinge 560 to adjust a receiving angle of the receiving block 510.

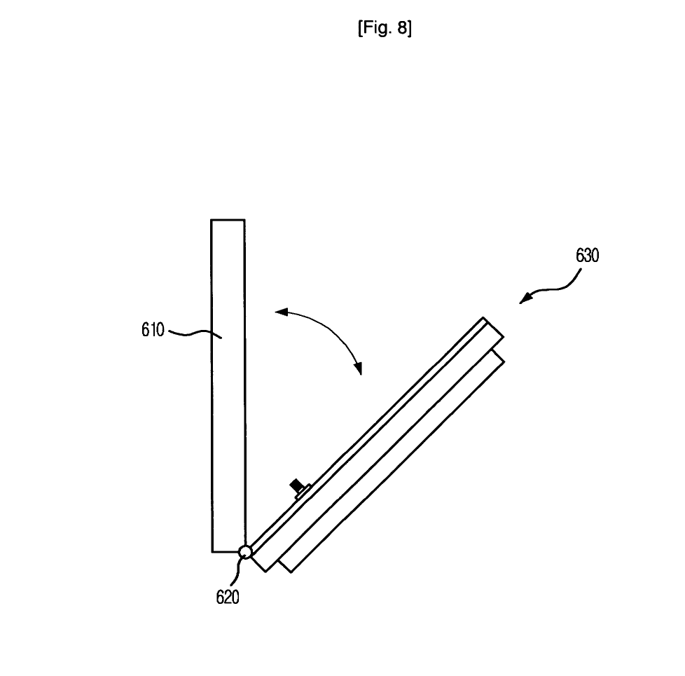

FIGS. 7 to 8 are detailed diagrams representing a transmitting antenna in FIG. 2.

As shown in FIG. 7, the transmitting antenna 630 is covered by a radome 632. The radome 632 protects the transmitting antenna 630 from outdoor environments such as snow, rain and dust. A signal from a receiving block is inputted to the transmitting antenna 630 through an input connector 636.

FIG. 8 shows a view for adjusting a radiation angle of the transmitting antenna 630.

The transmitting antenna 630 is rotatably connected to a supporting member 610 by a hinge 620. The supporting member 610 is installed on a portion of a shadow area in such a way that the transmitting antenna 630 efficiently radiates the radio frequency (RF) signal to the mobile stations in the shadow area. The transmitting antenna 630 is rotated around the hinge 620 to appropriately adjust a transmitting angle of the transmitting antenna 630 for radiating the RF signal effectively to scan the shadow area.

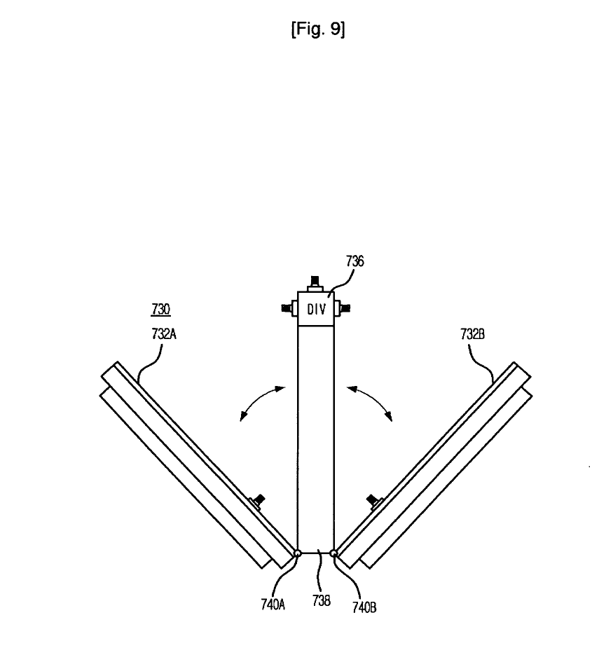

FIG. 9 is a detailed diagram showing dual directional microstrip patch array antenna employed as a pair of transmitting antennas in FIG. 2.

The dial directional microstrip patch array antenna 730 is used as a transmitting antenna, and it applies to a case that the length of a shadow area is longer than approximately, 3 km.

As shown in FIG. 9, the dual directional microstrip patch array antenna 730 includes a first microstrip patch array antenna 732A, a second microstrip patch array antenna 732B, a divider 736 and a supporting member 738 provided with a pair of hinges 740A, 740B. A received signal from the receiving block is divided by the divider 736 to a first signal and a second signal.

The first signal is radiated through the first microstrip patch array antenna 740A to a first direction and the second signal is radiated through the second microstrip patch array antenna 740B to a second direction, which is opposite direction of the first direction. The first and the second microstrip patch array antennas 732A, 732B are rotatably connected to the supporting member 738. Radiating angles of the first and the second microstrip patch array antennas 732A, 732B are adjusted by rotating the first and the second microstrip patch array antennas 732A, 734B around the hinges 740A, 740B, respectively.

As mentioned above, the present invention can eliminate a discontinuity problem by receiving a signal from a satellite by using a microstrip patch array antenna and radiating the signal to a mobile station in a shadow area by using a microstrip patch array antenna.

The present application contains subject matter related to Korean patent application No. KR 2003-0072769, filed in the Korean patent office on Oct. 18, 2003, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. An apparatus for repeating a signal from a satellite to a mobile station in a shadow area, the apparatus comprising:
means for receiving the signal and amplifying the received signal;
means for radiating the amplified signal to the shadow area; and
means for feeding the amplified signal to the radiating means.

2. The apparatus of claim 1, wherein the receiving means includes:
a microstrip patch array antenna for receiving the signal from the satellite; and
an amplifier for amplifying the received signal from the microstrip patch array antenna.

3. The apparatus of claim 2, wherein the radiating means is installed in the shadow area.

4. The apparatus of claim 2, wherein the microstrip patch array antenna and the amplifier are implemented as one piece and further includes a probe for transiting the signal received from the microstrip patch array antenna to the amplifier.

5. The apparatus of claim 1, wherein the radiating means is one directional microstrip patch array antenna.

6. The apparatus of claim 5, wherein the shadow area is an overpass.

7. The apparatus of claim 1, wherein the receiving means is located at a position where a line of sight to the satellite is secured.

8. The apparatus of claim 1, wherein the radiating means includes:
a dual directional antenna provided with a first microstrip patch array antenna and a second microstrip patch array antenna; and
means for dividing the signal received from the receiving means to a first portion and a second portion, and passing the first portion to the first microstrip patch array antenna and the second portion to the second microstrip patch array antenna.

9. The apparatus of claim 8, wherein the shadow area is an underpass.
